(19) United States
(12) Patent Application Publication
(10) Pub. No.: US 2017/0239767 A1
(43) Pub. Date: Aug. 24, 2017

(54) TOOL MAGAZINE

(71) Applicant: GROB-WERKE GmbH & Co. KG, Mindelheim (DE)

(72) Inventor: Alfred Hoebel, Lauben (DE)

(21) Appl. No.: 15/436,850

(22) Filed: Feb. 19, 2017

(30) Foreign Application Priority Data
Feb. 19, 2016 (DE) 10 2016 102 996.3

(51) Int. Cl. B23Q 3/155; B23Q 3/157

(52) U.S. Cl. CPC B23Q 3/15536; B23Q 3/15713; B23Q 3/15773

(57) ABSTRACT

Tool magazine for the provision of tools for a machine tool, wherein the tool magazine has a multiplicity of receiving positions for tools. A first tool can be removed from or inserted into a first receiving position along a removal direction, and at least one further receiving position for receiving a further tool is provided.

### BACKGROUND OF THE INVENTION

The invention relates to a tool magazine for the provision of tools for a machine tool, wherein the tool magazine has a multiplicity of receiving positions for tools and a first tool can be removed from or inserted into a first receiving position along a removal direction and the tool magazine has at least one further receiving position.

With various, chip-removal machining operations, such as milling, drilling, turning, grinding, polishing or similar processes which are carried out using machine tools, many different tools are often required for producing more complex workpieces.

Different embodiments of tool magazines for machine tools exist in order to make the logistics for these tools simple and, at the same time, keep the times required for tool-changing short. These tool magazines are usually designed as an assembly of the machine tool. Tool magazines of this kind often have transfer devices which pick up the tools from their storage locations and feed them automatically to the spindle of the machine as required. In order for the transfer device to be able to reach all tools whenever they are required for machining the workpiece, the individual tools are arranged next to one another in the tool magazine in the widest sense.

This arrangement of the tools next to one another is carried out in different ways, for example as a two-dimensional rack, as a moving magazine wheel, as a magazine chain or similar. Common to all these storage concepts is that each tool can be reached directly.

Such tool magazines, according to the prior art, have the disadvantage that the transfer device often has to cover long distances in order to reach individual tools, as, when there is a high number of tools, storage of the tools next to one another results in large extensions of the tool magazine. The consequence of long distances when changing tools is that a correspondingly long time is required for the movements of the transfer device.

A further disadvantage of known tool magazines is that a disproportionately large installation space is required for a larger number of storable tools, as only a small volume is used for tool storage and the greater part of the required installation space is lost in the form of space which has to be left free for movement of the transfer device in the tool magazine. This high installation space requirement for known tool magazines therefore constitutes an ineffective use of space on often restricted shop floors. At the same time, poorly used installation space and wasted shop floor areas for inefficient tool magazines impair the economic efficiency of manufacturing businesses which carry out complex workpiece machining with a larger number of tools.

### BRIEF SUMMARY OF THE INVENTION

The object of the invention is therefore to propose a tool magazine which has an improved use of space for tool storage compared with the prior art.

The object of the invention is achieved by a tool magazine for the provision of tools for a machine tool, wherein the tool magazine has a multiplicity of receiving positions for tools and a first tool can be removed from or inserted into a first receiving position along a removal direction, wherein, before or after the first receiving position in the removal direction, the tool magazine has at least one further receiving position which is intended for receiving a further tool.

In a tool magazine according to the invention, at least two tools are arranged one behind the other viewed in the removal direction. Here, removal direction is understood to mean the direction in which the appropriate tool can be removed from the magazine and in which the tool can also be reloaded into the magazine. If, in an embodiment, an automatically operating transfer device undertakes the movement of the tool, this transfer device, or at least part thereof, moves in just this described removal direction when removing and loading the tool.

In a tool magazine according to the invention, tools are therefore arranged next to one another as well as behind one another. This results in a significantly improved space utilization of the tool magazine, as tools can now be loaded in the tool magazine in three dimensions and not, as previously, only in two dimensions. The more tools are arranged behind one another in the removal direction, the higher the spatial packing density and therefore the space utilization for tool storage. Here, the widely differing arrangement concepts for tools are included in the invention, such as for example the arrangement in a rack-like form, wherein the tools are arranged in rows and columns and additionally, according to the invention, in planes behind one another. It is also possible for tools to be accommodated behind one another in other geometrically configured tool magazines. Two or more tools can also be arranged behind one another in the removal direction in magazine wheels, magazine belts, magazine chains or similar. In all these embodiments, each tool occupies its own receiving position in the tool magazine, wherein these receiving positions can be arranged next to one another or behind one another with respect to the removal direction.

According to the invention, at least one transfer device is provided which undertakes at least part of the transportation of the tools in the tool magazine and/or to an interface. In this embodiment of the invention, a transfer device is provided which carries out at least some of the movements in the tool magazine and/or also transports the tools to interfaces or directly to a tool spindle.

For example, this transfer device removes a tool from a receiving position in the tool magazine, then moves it to an interface formed by an insertion gripper, and hands over the removed tool to the insertion gripper at this interface.

A transportation or transfer of tools from such an interface back to the receiving position in the tool magazine is, of course, also possible. At the same time, the interface can also be formed by the spindle itself. In doing so, the entire movement of the tool or tools does not have to be undertaken by the transfer device; designs, in which the tool magazine or the receiving positions move, as in a magazine chain for example, are also conceivable. In this case, a portion of the movement or transfer of the tool is undertaken by the magazine chain and another portion by the transfer unit.

Furthermore, it is provided that the transfer device is rotatable about an axis of rotation. Preferably, it is also provided that it is movably mounted along at least one longitudinal axis. In this embodiment, the transfer device is rotatably mounted about an axis of rotation in the tool magazine. This rotatable mounting is particularly favorable when the individual receiving positions in the tool magazine are arranged on circular paths. However, the invention is not restricted to circular paths; other geometric forms of the arrangement, such as in ellipse form, linear form or a mixed form of linear and curved regions for example, are also possible. The various adjacently arranged receiving positions can be approached and reached by a simple rotational movement of the transfer device. An arrangement of a plurality of receiving positions behind one another, for example in concentric circular arcs, generates a high packing density of the tools when storing and, at the same time, enables a simple and stable design of the transfer device.

For the arrangement of a plurality of concentric circular arcs with receiving positions additionally above one another, at least one further movement direction of the transfer device is required. For this purpose, the transfer device is movably mounted along at least one longitudinal axis. For example, rows of receiving positions can be arranged in horizontally running circular arcs and, in addition, a plurality of such rows of receiving positions can be mounted vertically above one another. The transfer device is then designed such that a rotational movement about an axis of rotation and a translatory movement along at least one vertically running longitudinal axis is possible. This enables all receiving positions to be easily reached by a mixed movement of rotation and translation of the transfer device. Of course, in addition, further axes of rotation or longitudinal axes, along which the transfer device, or at least part of the transfer device, can move, can also be provided.

Furthermore, it is provided that the transfer device has three or more grippers, wherein a first gripper is provided to carry a tool to be loaded, a second gripper is provided to carry the tool to be removed, and at least one further gripper is provided as a temporary buffer store for a tool which is initially resting on a receiving position which is obstructing the loading and removal of the required tool. In this embodiment, a gripper of the transfer device is used as a buffer store for tools when loading or removing the tools into or from the receiving positions. If a tool, which is located in the tool magazine on a receiving position behind another tool, is required by the machine tool, then in order to remove just this required tool, the tool which is located in front of the required tool in the removal direction must be removed first. Only when this first tool has been removed is the path free for removing the required tool. While the required, second tool is being removed, the first tool which has been removed is held and buffered by a gripper. After the required tool has been removed by another gripper, the tool which was removed first and not required can then be reloaded into a receiving position of the tool magazine. This is then carried out by the gripper which had buffered the tool in the interim. The more receiving positions are arranged behind one another in the removal direction, the more grippers are required for buffering. As, in the worst case, the required tool can be located in the rearmost position in the removal direction, a number of grippers equal to the number of receiving positions existing behind one another minus the gripper for the actually required tool are required for buffering. In addition, a further gripper can be provided which carries the tool to be loaded, which, for example, is to be loaded at the receiving position from which the currently required tool is removed. In this case, the transfer device also brings a tool to be loaded at the same time when fetching the actually required tool. In the changeover operation which now follows, if necessary, one or more grippers remove tools which are to be buffered from receiving positions, one gripper removes the required tool, and another gripper loads the tool which has also been brought onto the required receiving position. By providing a plurality of grippers, the path of the transfer device within the tool magazine is minimized, as buffering takes place directly at the receiving positions. In doing so, the grippers can be arranged relative to one another in the form of a star. Alternatively, other forms of the gripper arrangement are possible, such as linearly behind one another for example. An alternative to buffering tools in grippers provided for the purpose at the transfer device is buffering on buffer locations. In this case, tools which are currently not required directly are set down on one or more buffer locations and, after removal of the requested tool, returned to their receiving positions. An advantage with this embodiment is that fewer grippers are required.

In a preferred embodiment of the proposal, it is provided that the transfer device has a carrier which is rotatable about the axis of rotation and at each end of which at least one gripper for receiving tools is provided. Preferably, two grippers are provided at one end. In this embodiment, the transfer device has a carrier which is rotatably attached around the axis of rotation. At the same time, this carrier can additionally be designed to be movable parallel to and/or at an angle to the axis of rotation. One or more grippers for receiving tools are attached at each end of the rotatably mounted carrier. If a tool is required at the machine tool, which, when viewed in the removal direction, is located behind another tool which is not required, then the gripper at one end of the carrier can first remove the tool which is not required from its receiving position. The transfer device, and therefore the carrier, then rotates about the axis of rotation. The gripper at the opposite end of the carrier then removes the required tool, to which access is now free. After a further rotational movement of the carrier, the gripper which is carrying the tool which was removed first can return it to its receiving position once more. In addition, one or more further grippers can be attached to one or to both ends of the carrier. As in the exemplary embodiment described above, these grippers can then buffer tools when removing or loading into the tool magazine.

Advantageously, it is provided that the receiving positions are movable and move relative to the transfer device when transferring tools. In this embodiment, the storage locations, i.e. the receiving positions in the tool magazine, are designed to be movable. This can be realized in the form of a magazine chain or a magazine wheel for example. Of course, receiving positions which are designed in the manner of a rack can also be designed to be movable. When transferring a tool, the receiving position on which the required tool is located is then moved towards the transfer device. The transfer device then only needs to make smaller movements to actually remove the tool from the receiving position. An advantage of this design is that the transfer device can be made simpler, as fewer directions of movement and degrees of freedom are required for this.

In an advantageous embodiment, it is provided that the receiving positions are substantially fixed and the transfer device moves relative to the receiving positions when transferring tools. In this embodiment, only the transfer device moves when transferring a tool. Here, the receiving positions of the stored tools in the tool magazine remain substantially fixed. An advantage of this embodiment is the simpler design of the receiving positions and their basic construction.

Inventively, it is provided that the tool magazine is located outside or inside the machine tool for which it provides the tools. A tool magazine according to one of the previously described embodiments can be arranged either outside or inside a machine tool. An arrangement inside the machine tool provides the advantage that the paths for the transfer of tools to the tool spindle are very short. On the other hand, an arrangement of a tool magazine outside the machine tool offers the possibility of carrying out maintenance or monitoring work on the tools while the machine tool is machining a workpiece. With an arrangement outside the machine tool, the risks due to the ongoing machining process for personnel who are charged with working in the tool magazine are significantly less than with an arrangement inside the machine tool.

In an advantageous embodiment, it is provided that a multiplicity of receiving positions are arranged behind one another or above one another in a plurality of levels. In this embodiment of the invention, receiving positions are arranged in a plurality of levels. An arrangement in a plurality of levels ensures even better utilization of the shop floor areas, as further receiving positions are created upwards in the third dimension without requiring more base area. At the same time, the outlay for extending the transfer device remains small, as it is only necessary to provide a further linear axis of movement for the transfer device or the receiving positions. According to the invention, the tools are then arranged in the individual levels in receiving positions which are arranged behind one another and next to one another with respect to the removal direction.

Furthermore, it can be provided that the tool magazine is designed as a rack magazine, disk magazine, ring magazine or similar, and the receiving positions are formed by a plate-shaped element of the tool magazine, in which receiving slots are made, and the tools are arranged in these receiving slots behind one another in the removal direction. In this embodiment, a plate-shaped element forms the base of the receiving positions. Receiving slots, which receive the stored tools behind one another, are made in this plate-shaped element. Here, the removal direction runs parallel to these receiving slots. The tools are simply suspended in these slots when loading. In doing so, reception can be assisted by interlocking or also by means of supporting elements such as spring-loaded pressing elements, pincers or similar. The arrangement of the receiving positions in plate-shaped elements which are provided with receiving slots constitutes a simple, stable and cost-effective storage concept. At the same time, the plate-shaped base elements with the receiving slots can in turn be arranged with respect to one another in different ways. Here, rack, disk and ring magazines represent known embodiments. In addition, plate-shaped elements of this kind can also be fitted in belt or chain-shaped tool magazines.

In an advantageous embodiment, it is provided that at least one indexing region, which determines the radial/rotational alignment of a tool in the receiving position, is provided at the receiving slot. In this embodiment, one or more indexing regions are provided in the receiving slots. These areas ensure that the tools which are stored in the receiving positions always have the same and known rotational alignment with respect to the receiving slot or the receiving positions. These indexing regions can be realized mechanically by interlocking. Hence, for example, the negative form of alignment elements at the tool shafts can be provided at the edges of the receiving slot. The alignment elements of the tool shafts are then rotated into the negative forms of the receiving slots when loading. Alternatively, indexing regions which are designed in a different manner are, of course, also possible, for example with an electrical or magnetic functional principle.

In a preferred embodiment of the proposal, it is provided that a chain magazine is provided for the tool magazine and the receiving position is arranged on at least one chain link. In this embodiment, the invention is realized in combination with a known chain magazine. Here, the chain magazine has individual chain links which are arranged movably with respect to one another. Receiving positions are arranged behind one another, viewed in the removal direction, in at least one of these chain links.

The object of the invention is likewise achieved by a machine tool having at least one tool magazine according to one or more of the previously described embodiments. A machine tool which has a tool magazine according to the invention likewise improves the space utilization for tool storage and tool provision. At the same time, the machine tool can have a tool magazine according to one of the already described embodiments in its interior, directly adjacent thereto or close thereto.

In an advantageous embodiment, it is provided that at least one first tool magazine according to the invention according to one or more of the previously described embodiments is located outside the machine tool and a second tool magazine is provided in or at the machine tool. In this embodiment of a machine tool, two tool magazines are provided. At least one tool magazine according to the invention according to one of the embodiments described above is provided outside the machine tool and connected to the machine tool via an interface. This arrangement, outside or adjacent to the machine tool, has the advantage that maintenance and monitoring work can be carried out comfortably outside the working area of the machine tool.

Furthermore, the removal and fitting of tools by an operator is considerably easier with a tool magazine arranged outside the machine tool for reasons of accessibility. Furthermore, with a machine tool of this embodiment, a second tool magazine is provided inside or at the machine tool. This tool magazine can be technically very simple, for example, and designed in accordance with the prior art. A smaller number of tools are stored in the second tool magazine. Tool changing is carried out between this second tool magazine and the spindle of the machine tool. In this way, tools are only brought from the second tool magazine directly for machining workpieces in the spindle of the machine tool. Via an interface, the first tool magazine according to the invention fills the second tool magazine, from which tool changing is then carried out at the spindle. This embodiment has the advantage that existing machine tools with simply designed tool magazines can be quickly and easily combined with a tool magazine according to the invention with considerably optimized space utilization. Even with existing machinery, shop floor areas can therefore be utilized more efficiently by retrofitting a tool magazine according to the invention. This is particularly interesting when a manufacturer envisages the machining of more complex workpieces which require a larger number of different machining tools than before. The second tool magazine in or at the machine tool can, of course, also be designed as a tool magazine according to the invention. The space utilization for tool storage is further optimized by the combination and interaction of two tool magazines according to the invention.

The object of the invention is also achieved by the use of a tool magazine according to one or more of the previously described embodiments for the arrangement and provision of tools which have an identical design and are intended for identical machining steps on workpieces in adjacent receiving positions which are arranged behind one another in the removal direction. Many machine tools have two or more similarly designed tool spindles. With such machine tools, a plurality of identical workpieces can be machined simultaneously, wherein a workpiece is machined by each individual spindle. Such simultaneous machining of a plurality of workpieces assumes a plurality of identically designed tools which are each inserted into one of the spindles which is working in parallel with the others. The object of the invention to achieve better space utilization for tool storage is also achieved by the use of a tool magazine according to the invention for storing such identically designed tools, also referred to as twin tools, which are required simultaneously for parallel multi-spindle machining for identical machining steps. Here, the similarly designed tools of a working operation are stored in adjacent, adjoining receiving positions which are located one behind the other in the removal direction. All identically designed tools are therefore stored together in a kind of compartment and in a space-saving manner compared with the prior art.

Finally, the object is also achieved by a method for removing tools from a tool magazine of a machine tool.

The method can be carried out in particular with a tool magazine according to the invention and/or with a machine tool according to the invention. In doing so, it is possible to call upon all embodiments and variants described herein.

The method includes the following steps:
A) Removal of a requested tool from the receiving position if the requested tool is directly accessible,
B) Removal of another tool which is stored in a receiving position which is located in front of the requested tool in the removal direction, buffering of this other tool and subsequent removal of the requested tool from its receiving position if the requested tool is not directly accessible.

A particular removal operation can be carried out by means of a transfer device which is rotatable about an axis of rotation and has a carrier which is rotatable about the axis of rotation and at each end of which at least one gripper for receiving tools is provided. In this regard, it is possible to call upon all embodiments and variants described herein.

A method according to the invention for removing tools from a tool magazine initially includes a decision as to whether a required tool is located on a receiving position which is directly accessible or not. For the case where a tool magazine according to one of the embodiments described above is used, a required tool could be located in a receiving position which is located behind another receiving position in the removal direction in which a tool which is not required is stored. In this case, the required tool is not directly accessible. For the case where a required tool is not directly accessible, the tool which is preventing the required tool from being removed is first removed and buffered. The required or requested tool is then removed from its receiving positions. For the case where the required and requested tool is directly accessible, this is removed directly from its receiving positions without further steps being necessary.

Furthermore, it is provided that the removed tool is fed directly to a spindle of a machine tool or that, before being fed to a spindle of a machine tool, the removed tool is buffered in a second tool magazine or that the buffering of the tools is undertaken by the transfer device. The tool removed in accordance with a method according to the invention can be used in different ways. It is therefore possible that the removed tool is fed directly to a spindle of a machine tool where it is used for a machining operation of a workpiece. Alternatively, the removed tool can first be transferred to a second tool magazine where it is buffered and from where it is then finally fitted into the tool spindle. Furthermore, alternatively or in addition to a direct transfer to a spindle or buffering in a further tool magazine, the transfer device can undertake a buffering of the tools. Such a buffering by the transfer device is particularly favorable when the requested tool is not directly accessible and another tool which is not required must first be removed to free up the path for removing the required tool. This tool, which is removed first and is not required, is then advantageously buffered by the transfer device, which ensures smooth removal of the required tool.

In this context, it is particularly pointed out that all features and characteristics described with regard to the device, and also avenues of approach, can also be transferred accordingly with regard to the formulation of the method according to the invention and can be used within the meaning of the invention, and are seen as disclosed. The same also applies in the reverse direction; this means that constructional features, that is to say features pertaining to the device, only mentioned with regard to the method can also be taken into account and claimed within the framework of the device claims, and are likewise included in the disclosure.

### BRIEF DESCRIPTION OF THE DIFFERENT VIEWS OF THE DRAWING

The invention is shown schematically in the drawings, in particular in exemplary embodiments. In the drawings:

FIG. 1 shows a plan view on a machine tool having an embodiment of a tool magazine according to the invention,

FIG. 2 shows a perspective view of a plurality of receiving positions of an embodiment of a tool magazine according to the invention,

FIG. 3 shows a perspective overall view of an embodiment of a tool magazine according to the invention.

### DETAILED DESCRIPTION OF THE PREFERRED EMBODIMENT

In the figures, identical or corresponding elements are in each case designated by the same references and, unless expedient, are therefore not described again. The disclosures contained in the overall description can be transferred analogously to identical parts with the same references or same component designations. The positional information chosen in the description, such as for example top, bottom, side etc., relates to the figure directly described and shown, and in the event of a positional change, is to be conferred analogously on the new position. Furthermore, individual characteristics or combinations of characteristics from the different exemplary embodiments shown and described can also constitute independent, inventive solutions or solutions according to the invention in their own right.

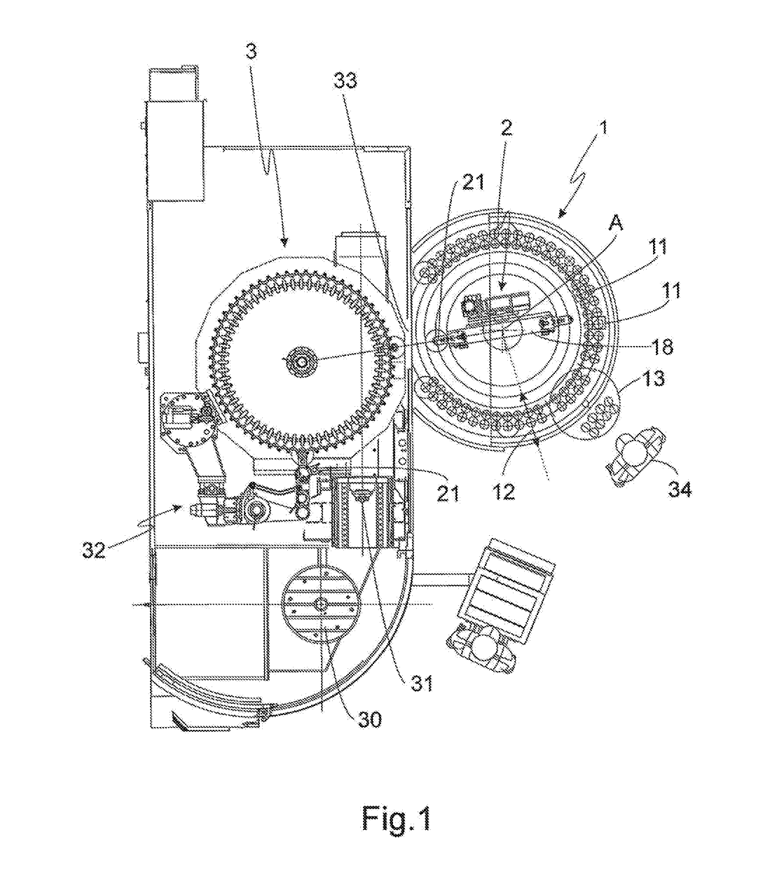

FIG. 1 shows a plan view on a machine tool having an embodiment of a tool magazine according to the invention. A machine tool is shown on the left-hand side of FIG. 1. Here, the clamping table 30 for the workpiece or workpieces can be seen at the bottom, and the working spindle 31 is located on the right above the clamping table 30. Here, a conventional tool magazine 3, with which the tools are stored and transported with the help of a magazine wheel, is located inside the machine tool. The tools are transported from the tool magazine 3 to the working spindle 31 and inserted therein by means of the changing device 32. Likewise, tools which are no longer needed are removed by the changing device 32 from the working spindle and returned to the tool magazine 3. Here, the changing device 32 is designed as a multi-jointed manipulator arm which has a gripper 21 at its tip. A further tool magazine 1 according to an embodiment of the invention is shown adjacent to the machine tool shown on the left. The machine tool and the tool magazine 1 are connected to one another by means of the connecting opening 33. The tools stored in the tool magazine 1 are arranged behind one another in multiple rows. Each tool is stored on its own receiving position 11, wherein each receiving position 11 can only receive one tool. In the case shown, the receiving positions 11 are arranged next to one another and behind one another. In the plan view shown, receiving positions are initially arranged in the form of a circular arc around an axis of rotation A which runs into the plane of the drawing. Here, the direction 12 for removing tools from this circular-arc-shaped arrangement runs radially with respect to the axis of rotation A. When tools are removed from their receiving positions 11, these tools are moved along the removal direction at least at the start of the removal. Once they have actually been removed from the receiving positions 11, the tools are then of course also moved in other directions in order to reach the machine tool and the working spindle 31. In the tool magazine 1 shown in FIG. 1, receiving positions 11 for tools are arranged in two circular arcs running concentrically around the axis of rotation A. Here, a receiving position 11 of the outer circular arc lies behind a receiving position 11 of the inner circular arc viewed in the removal direction 12. Of course, more than two receiving positions 11 can be arranged behind one another in the removal direction 12. In FIG. 1, it can be clearly seen that the tool magazine 1 designed according to the invention can store nearly twice as many tools as the conventional tool magazine 3, wherein the external dimensions or the required installation space of both tool magazines is nearly identical. The tool magazine 1 is additionally designed in a plurality of levels vertically above one another in order to be able to provide even more receiving positions 11 for storing tools. The transfer device 2, rotatably mounted about the axis of rotation A, can be seen in the middle of the tool magazine 1. The tools are removed from the receiving positions 11, buffered and reloaded with the help of the transfer device 2. In the case shown, the transfer device 2 is formed by a carrier 18 which has a gripper 21 at each of its ends. When transferring tools, the transfer device 2 moves in different directions: the carrier 18 is rotatably mounted about the axis of rotation A, wherein a suitable rotary drive is also provided. The grippers 21 can additionally move linearly backwards and forwards along the longitudinal direction of the carrier 18. In addition, the carrier 18 moves together with the grippers 21 in the vertical direction, i.e. along the axis of rotation A which runs into the plane of the drawing. Further degrees of freedom for the transfer device can of course be provided. In the case shown, the transfer device 2 hands over a tool which has been removed from the tool magazine 1 through the connecting opening to the tool magazine 3, which in turn is arranged in the interior of the machine tool. However, in other embodiments, it would also be conceivable that the transfer device 2 hands over a removed tool directly to the working spindle 31. One or more gate systems 13 are provided in order to populate the tool magazine 1 with tools. By means of these gate systems 13, tools can be loaded into and removed from the tool magazine 1 by an operator 34.

The tool magazine 3 shown accordingly in FIG. 1 as the prior art can also be formed by a tool magazine according to the invention, for example in the form of a tool magazine 1 shown on the right next to the processing machine.

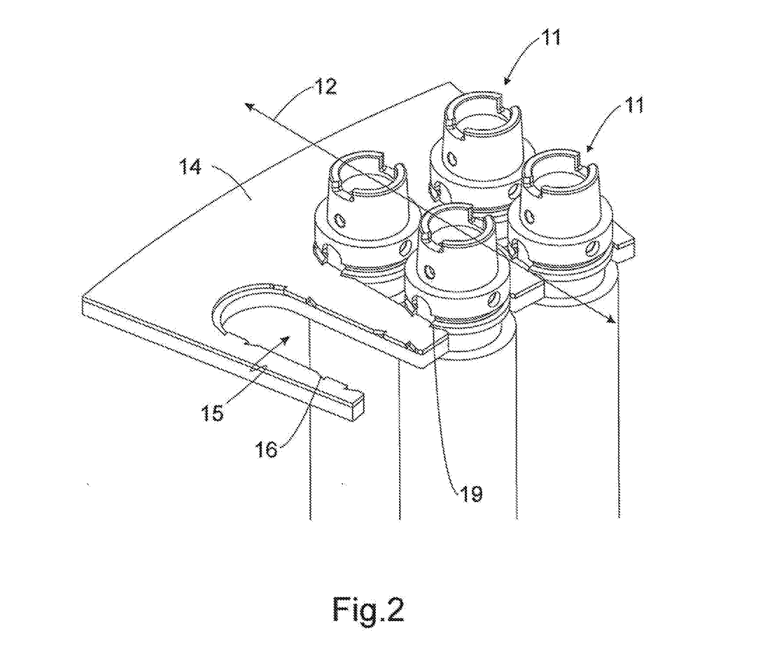

FIG. 2 shows a perspective view of a plurality of receiving positions 11 of an embodiment of a tool magazine according to the invention. In the embodiment shown, the base of the receiving positions 11 is formed by a plate-shaped element 14. Here, two receiving positions 11 in each case are arranged in receiving slots 15. At the same time, the two receiving positions 11 of a receiving slot 15 are arranged behind one another in the removal direction 12. In the embodiment shown, indexing regions 16 are in each case provided at the receiving slots 15 in each receiving position 11. These indexing regions serve to always load the tools in the same rotational alignment in the receiving positions 11. An identical rotational alignment at all times ensures problem-free insertion of the tools in the machine tool. In the case shown, the indexing regions 16 are designed as recesses into which the appropriate key regions 19 of the tools can be introduced in an interlocking manner.

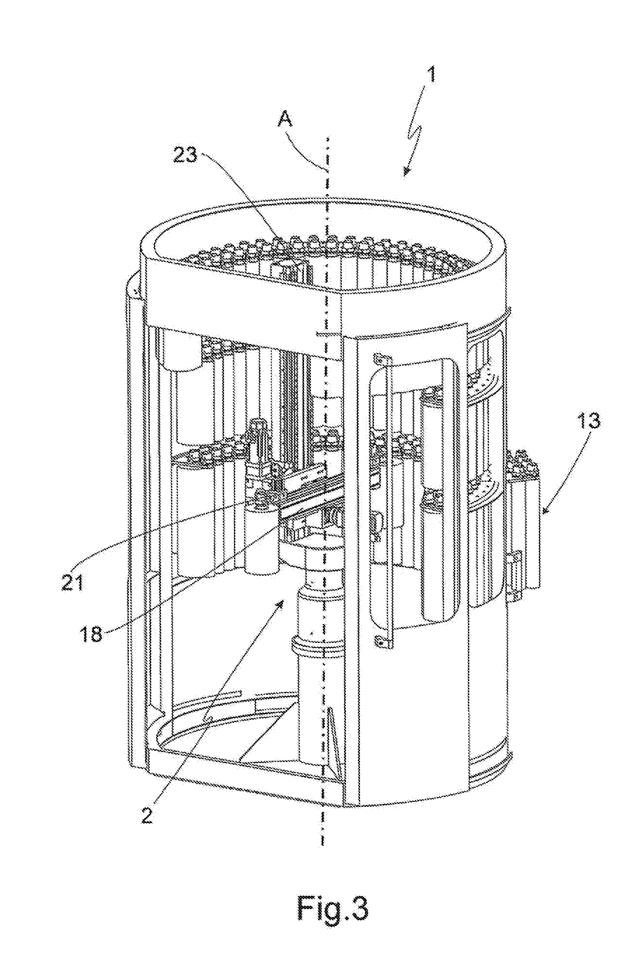

FIG. 3 shows a perspective overall view of an embodiment of a tool magazine 1 according to the invention. The tool magazine 1 in FIG. 3 corresponds to the tool magazine 1 in FIG. 1. Considerably more levels of tools or receiving positions 11 can be seen above one another in the perspective view of FIG. 3. The transfer device 2, which is rotatably arranged about the axis of rotation A, can be seen in the center of the tool magazine 1. In order to carry out the rotational movements about the axis of rotation A, a rotary drive is provided in the bottom part of the transfer device 2. The transfer device 2 has a horizontally running carrier 18, which here runs horizontally and at the ends of which grippers 21 are attached in each case. In the case shown, the gripper 21 at the front end of the carrier 18 is presently carrying a tool. The carrier 18 can additionally be moved linearly along its longitudinal direction. In order to be able to reach the various levels, the whole carrier 18 with the grippers 21 can also be moved in the vertical direction along or parallel to the axis of rotation A. In the case shown, a linear guide 23 with appropriate drive is provided on the transfer device 2 for this vertical movement. On the right-hand side of the depicted tool magazine 1 can be seen tools which have been removed from the tool magazine 1 or are to be introduced into the tool magazine 1 via the gate system 13. The forward-facing opening of the tool magazine 1 can be closed by means of safety doors. The tool magazine shown can therefore be completely secured against access by operators. A tool magazine 1 according to the invention can, as shown, be accommodated in its own housing. Alternatively however, it is also possible to arrange a tool magazine 1 inside a machine tool and its housing.

Possible characteristics of the proposal are reproduced in structured form below. The following characteristics, which are reproduced in structured form, can be combined with one another in any way and can be incorporated into the claims of the application in any combination. It is clear to the person skilled in the art that the invention ensues from the subject matter with the fewest characteristics. In particular, advantageous or possible embodiments, but not the only possible embodiments of the invention, are reproduced below.

The invention comprises:

A tool magazine for the provision of tools for a machine tool, wherein the tool magazine has a multiplicity of receiving positions for tools and a first tool can be removed from or inserted into a first receiving position along a removal direction, wherein, before or after the first receiving position in the removal direction, the tool magazine has at least one further receiving position which is intended for receiving a further tool.

A tool magazine as previously stated, wherein at least one transfer device is provided which undertakes at least part of the transportation of the tools in the tool magazine and/or to an interface.

A tool magazine as previously stated, wherein the transfer device can be rotated about an axis of rotation and/or is movably mounted along at least one longitudinal axis.

A tool magazine as previously stated, wherein the transfer device has three or more grippers, wherein a first gripper is provided to carry a tool to be loaded, a second gripper is provided to carry the tool to be removed, and at least one further gripper is provided as a temporary buffer store for a tool which is initially resting on a receiving position which is obstructing the loading and removal of a tool.

A tool magazine as previously stated, wherein the transfer device has a carrier which is rotatable about the axis of rotation and at the ends of which at least one gripper, at one end preferably also two grippers, are provided.

A tool magazine as previously stated, wherein the receiving positions are movable and move relative to the transfer device when transferring tools.

A tool magazine as previously stated, wherein the receiving positions are substantially fixed and the transfer device moves relative to the receiving positions when transferring tools.

A tool magazine as previously stated, wherein the tool magazine is located outside or inside the machine tool for which it provides the tools.

A tool magazine as previously stated, wherein a multiplicity of receiving positions are arranged behind one another or above one another in a plurality of levels.

A tool magazine as previously stated, wherein the tool magazine is designed as a rack magazine, disk magazine, ring magazine or similar, and the receiving positions are formed by a plate-shaped element of the tool magazine, in which receiving slots are made, and the tools are arranged in these receiving slots behind one another in the removal direction.

A tool magazine as previously stated, wherein at least one indexing region, which determines the radial/rotational alignment of a tool in the receiving position, is provided at the receiving slot.

A tool magazine as previously stated, wherein a chain magazine is provided for the tool magazine and the receiving position is arranged on at least one chain link.

The invention further includes a machine tool having at least one tool magazine according to one or more of the preceding embodiments.

A machine tool as previously stated, wherein at least one first tool magazine according to one or more of the previously described embodiments is located outside the machine tool and a second tool magazine is provided in or at the machine tool.

The invention also includes a use of a tool magazine according to one or more of the preceding embodiments for the arrangement and provision of tools which have an identical design and are intended for identical machining steps on workpieces in adjacent receiving positions which are arranged behind one another in the removal direction.

The invention also includes a method for removing tools from a tool magazine of a machine tool comprising the steps: A) Removal of a requested tool from the receiving position if the requested tool is directly accessible, B) Removal of another tool which is stored in a receiving position which is located in front of the requested tool in the removal direction, buffering of this other tool and subsequent removal of the requested tool from its receiving position if the requested tool is not directly accessible.

The method can be carried out in particular by means of a previously mentioned tool magazine and/or by means of a previously mentioned machine tool. Removal can be carried out in particular by means of a previously mentioned transfer device.

The previously stated method, alternatively comprising the steps that the removed tool is fed directly to a spindle of a machine tool or that, before being fed to a spindle of a machine tool, the removed tool is buffered in a second tool magazine or that the buffering of the tools is undertaken by the transfer device.

The claims submitted with the application and submitted later are without prejudice for the achievement of further protection.

If on closer inspection here, particularly also of the relevant prior art, it should be found that one or other characteristic, although favorable for the object of the invention, is however not of decisive importance, then, of course, a formulation which no longer features such a characteristic, particularly in the main claim, is sought at this stage. Such a sub-combination is also covered by the disclosure of this application.

It must further be noted that the embodiments and variants of the invention described in the various embodiments and shown in the figures can be combined with one another at will. In doing so, individual or several characteristics can be interchanged as required. These combinations of characteristics are likewise disclosed.

The counter-references stated in the dependent claims refer to the further embodiment of the subject matter of the main claim by way of the characteristics of the respective sub-claim. However, these are not to be understood as a renunciation of the achievement of independent, objective protection for the characteristics of the referenced sub-claims.

Characteristics which have been disclosed only in the description, and also individual characteristics from claims which include a multiplicity of characteristics, may be incorporated into the independent claim/claims at any time as being of significance essential to the invention for differentiation from the prior art, including when such characteristics have been mentioned in conjunction with other characteristics or achieve particularly favorable results in conjunction with other characteristics.

Although the invention has been described based on particular exemplary embodiments which are presented in great detail, it is pointed out that this is only by way of explanation and that the invention is not necessarily restricted thereto, as alternative exemplary embodiments and procedures are clear to persons skilled in the art with regard to the disclosure. Changes, which can be made without deviating from the content of the described invention, are accordingly taken into account.

1. A tool magazine for the provision of tools for a machine tool, wherein the tool magazine has a multiplicity of receiving positions for tools and a first tool can be removed from or inserted into a first receiving position along a removal direction, wherein, before or after the first receiving position in the removal direction, the tool magazine has at least one further receiving position which is intended for receiving a further tool, characterized in that at least one transfer device is provided which undertakes at least part of the transportation of the tools in the tool magazine and/or to an interface, and the transfer device is rotatable about an axis of rotation, and the transfer device has a carrier which is rotatable about the axis of rotation and at each end of which at least one gripper for receiving tools is provided.

2. The tool magazine according to claim 1, characterized in that the transfer device is movably mounted along at least one longitudinal axis.

3. The tool magazine according to claim 1, characterized in that the transfer device has three or more grippers, wherein a first gripper is provided to carry a tool to be loaded, a second gripper is provided to carry the tool to be removed, and at least one further gripper is provided as a temporary buffer store for a tool which is initially resting on a receiving position which is obstructing the loading and removal of a tool.

4. The tool magazine according to claim 1, characterized in that the receiving positions are movable and move relative to the transfer device when transferring tools.

5. The tool magazine according to claim 1, characterized in that the receiving positions are substantially fixed and the transfer device moves relative to the receiving positions when transferring tools.

6. The tool magazine according to claim 1, characterized in that two grippers are provided at one end of the carrier.

7. The tool magazine according to claim 1, characterized in that a multiplicity of receiving positions are arranged behind one another or above one another in a plurality of levels.

8. The tool magazine according to claim 1, characterized in that the tool magazine is designed as a rack magazine, disk magazine, ring magazine or similar, and the receiving positions are formed by a plate-shaped element of the tool magazine, in which receiving slots are made, and the tools are arranged in these receiving slots behind one another in the removal direction.

9. The tool magazine according to claim 1, characterized in that at least one indexing region, which determines the radial/rotational alignment of a tool in the receiving position, is provided at the receiving slot.

10. The tool magazine according to claim 1, characterized in that a chain magazine is provided for the tool magazine and the receiving position is arranged on at least one chain link.

11. A machine tool having at least one tool magazine according to claim 1.

12. The machine tool according to claim 11, characterized in that the tool magazine is located outside the machine tool and a further tool magazine is provided in or at the machine tool.

13. A method for removing tools from a tool magazine of a machine tool comprising the steps:
A) Removal of a requested tool by means of a transfer device, which is rotatable about an axis of rotation and has a carrier which is rotatable about the axis of rotation and at each end of which at least one gripper for receiving tools is provided, from the receiving position if the requested tool is directly accessible,
B) Removal, by means of the transfer device, of another tool, which is stored in a receiving position which is located in front of the requested tool in the removal direction, buffering of this other tool and subsequent removal of the requested tool by means of the transfer device from its receiving position if the requested tool is not directly accessible.

14. The method according to claim 13, characterized in that the removed tool is fed directly to a spindle of a machine tool.

15. The method according to claim 13, characterized in that, before being fed to a spindle of a machine tool, the removed tool is buffered in a second tool magazine or that the buffering of the tools is undertaken by the transfer device.
